(19) United States
(12) Patent Application Publication
(10) Pub. No.: US 2022/0318595 A1
(43) Pub. Date: Oct. 6, 2022

(54) METHODS, SYSTEMS, ARTICLES OF MANUFACTURE AND APPARATUS TO IMPROVE NEURAL ARCHITECTURE SEARCHES

(71) Applicant: Intel Corporation, Santa Clara, CA (US)

(72) Inventors: Sharath Nittur Sridhar, San Diego, CA (US); Daniel Cummings, Austin, TX (US); Juan Pablo Munoz, Folsom, CA (US); Anthony Sarah, San Diego, CA (US)

(21) Appl. No.: 17/848,226

(22) Filed: Jun. 23, 2022

(51) Int. Cl. G06N 3/04; G06N 5/04; G06N 5/02

(52) U.S. Cl. CPC G06N 3/04; G06N 5/04; G06N 5/022

(57) ABSTRACT

Methods, apparatus, systems, and articles of manufacture are disclosed to improve neural architecture searches. An example apparatus includes similarity verification circuitry to identify candidate networks based on a combination of a target platform type, a target workload type to be executed by the target platform type, and historical benchmark metrics corresponding to the candidate networks, the candidate networks associated with performance metrics. The example apparatus also includes likelihood verification circuitry to categorize (a) a first set of the candidate networks based on a first one of the performance metrics corresponding to first tier values, and (b) a second set of the candidate networks based on a second one of the performance metrics corresponding to second tier values, and extract first features corresponding to the first set of the candidate networks and extract second features corresponding to the second set of the candidate networks. The example apparatus also includes network analysis circuitry to improve network analysis efficiency by providing the first features and the second features to a network analyzer to identify particular ones of the candidate networks.

### FIELD OF THE DISCLOSURE

This disclosure relates generally to neural network searching and, more particularly, to methods, systems, articles of manufacture and apparatus to improve neural architecture searches.

### BACKGROUND

In recent years, neural networks have emerged with a vast number of different configurations and types. Some neural network configurations may exhibit particular capabilities that are better or worse than other neural network configurations. Typically, neural networks have a particular number of layers, take particular data as input, apply particular weights, and apply particular bias values to their outputs.

### BRIEF DESCRIPTION OF THE DRAWINGS

FIG. 1 is a schematic illustration of an example neural architecture search (NAS) system to improve neural architecture search efficiency.

FIG. 2A is a schematic illustration of an example network knowledge database of the NAS system of FIG. 1.

FIG. 2B is a schematic illustration of a probability distribution information table of the example network knowledge database of FIG. 2A.

FIGS. 3 and 4 are flowcharts representative of example machine readable instructions and/or example operations that may be executed by example processor circuitry to implement the NAS system of FIG. 1.

FIG. 5 is a block diagram of an example processing platform including processor circuitry structured to execute the example machine readable instructions and/or the example operations of FIGS. 3 and 4 to implement the NAS system of FIG. 1.

FIG. 6 is a block diagram of an example implementation of the processor circuitry of FIG. 5.

FIG. 7 is a block diagram of another example implementation of the processor circuitry of FIG. 5.

FIG. 8 is a block diagram of an example software distribution platform (e.g., one or more servers) to distribute software (e.g., software corresponding to the example machine readable instructions of FIGS. 3 and 4) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

An architecture of a neural network (NN) (sometimes referred to as an “architecture,” a “network architecture” or a “NN architecture”) includes many different parameters. As such, a network combination of characteristics and/or parameters is referred to as a type of architecture, which may include a particular combination of layer and/or activation types to perform particular tasks, or may include a particular combination of operations represented in the form of a computational graph. Parameters that make up a NN include, but are not limited to a number of layers of the NN, a number of nodes within each layer of the NN, a type of operation(s) performed with the NN (e.g., convolutions), a particular kernel size/dimension (e.g., 3×3). In the event a NN architecture is built and/or otherwise generated, the NN is expected to accomplish some sort of objective, such as image recognition, character recognition, etc. Still further, different NNs exhibit different performance characteristics (e.g., accuracy, latency, power consumption, memory bandwidth) that can be influenced by the type of input data to be processed and/or the type of computational resource that executes the NN.

Artificial intelligence (AI), including machine learning (ML), deep learning (DL), and/or other artificial machine-driven logic, enables machines (e.g., computers, logic circuits, etc.) to use a model to process input data to generate an output based on patterns and/or associations previously learned by the model via a training process. For instance, the model may be trained with data to recognize patterns and/or associations and follow such patterns and/or associations when processing input data such that other input(s) result in output(s) consistent with the recognized patterns and/or associations.

Many different types of machine learning models and/or machine learning architectures exist. In general, implementing a ML/AI system typically involves two phases, a learning/training phase and an inference phase. In the learning/training phase, a training algorithm is used to train a model to operate in accordance with patterns and/or associations based on, for example, training data. In general, the model includes internal parameters that guide how input data is transformed into output data, such as through a series of nodes and connections within the model to transform input data into output data. Additionally, hyperparameters are used as part of the training process to control how the learning is performed (e.g., a learning rate, a number of layers to be used in the machine learning model, etc.). Hyperparameters are defined to be training parameters that are determined prior to initiating the training process.

Different types of training may be performed based on the type of ML/AI model and/or the expected output. For example, supervised training uses inputs and corresponding expected (e.g., labeled) outputs to select parameters (e.g., by iterating over combinations of select parameters) for the ML/AI model that reduce model error. As used herein, labelling refers to an expected output of the machine learning model (e.g., a classification, an expected output value, etc.) Alternatively, unsupervised training (e.g., used in deep learning, a subset of machine learning, etc.) involves inferring patterns from inputs to select parameters for the ML/AI model (e.g., without the benefit of expected (e.g., labeled) outputs). In examples disclosed herein, once training is complete, one or more models are deployed for use as an executable construct that processes an input and provides an output based on the network of nodes and connections defined in the model. The model(s) is stored at any storage location, and then be executed by a computing device and/or platform.

Once trained, the deployed model may be operated in an inference phase to process data. In the inference phase, data to be analyzed (e.g., live data) is input to the model, and the model executes to create an output. This inference phase can be thought of as the AI “thinking” to generate the output based on what it learned from the training (e.g., by executing the model to apply the learned patterns and/or associations to the live data). In some examples, input data undergoes pre-processing before being used as an input to the machine learning model. Moreover, in some examples, the output data may undergo post-processing after it is generated by the AI model to transform the output into a useful result (e.g., a display of data, an instruction to be executed by a machine, etc.).

In some examples, output of the deployed model may be captured and provided as feedback. By analyzing the feedback, an accuracy of the deployed model can be determined. If the feedback indicates that the accuracy of the deployed model is less than a threshold or other criterion, training of an updated model can be triggered using the feedback and an updated training data set, hyperparameters, etc., to generate an updated, deployed model.

In view of the relatively large number of different influences, determining an optimal NN may consume a similarly large amount of time. As used herein, “optimal” refers to a particular performance improvement (e.g., improved accuracy, improved speed, improved (e.g., lower) power consumption, etc.) that satisfies a threshold change from a prior NN architecture configuration. In some examples, an optimum NN is based on a performance improvement that illustrates diminishing returns from one iteration to the next, such as an accuracy metric that does not improve by more than one percentage point, becomes asymptotically stagnant, or does not change from one iteration to the next. Further still, the number of potential permutations of different NN architecture design choices renders the task of determining an optimal NN (sometimes referred to as a Neural Architecture Search (NAS)) impossible for human effort without computational assistance.

Efforts to perform a NAS to identify optimized and/or otherwise candidate NN architectures (or particular combinations of NN architecture characteristics) are typically focused on a specified hardware platform (e.g., a target platform type) for a given task. However, such efforts do not consider particular NN architecture parameters and/or characteristics that could be relevant prior to beginning the search effort. Stated differently, such search efforts begin the search task without parameter/characteristic granularity and/or the beneficial foresight of previously executed search efforts that may represent helpful starting search conditions that, if applied, ultimately reduce an amount of time to identify an optimized and/or otherwise candidate NN architecture. Additionally, such search efforts typically fail to consider particular starting search conditions that are known to work very poorly in a particular circumstance. For instance, in the event prior search efforts have observed that a particular task with particular adjacency relationships that execute on a particular hardware platform (e.g., a particular hardware platform type, such as a PC, a server with a particular processor type, a rack with GPUs, etc.) perform rather poorly (e.g., in view of performance metric thresholds), then search efforts can be improved (e.g., occur faster and with greater accuracy) in the event those particular architectural parameter combinations are not suggested, tested, labeled as poor and/or otherwise withheld from evaluation in the NAS. In some examples, particular features (e.g., NN characteristics and/or parameters) that are labeled as relatively poor performers for a given task and/or platform combination are beneficial for network analyzers as inputs for one or more search algorithms because the labeled inputs facilitate efficient determinations of what features/combinations do not work particularly well. This is in contrast to existing techniques in which a network analyzer or NAS search effort takes candidate input data as an unlabeled opportunity for a solution, when in fact some of the inputs are poor choices. As such, if those particular unlabeled starting search conditions are used as inputs during a traditional NAS attempt, using ineffective or poorly performing NN architecture parameters causes the NAS to take longer to execute (e.g., more iterations will be required to reach a conversion point than would otherwise be needed if the particular iterations were withheld from consideration).

Examples disclosed herein improve neural architecture searches by, in part, initiating and/or otherwise establishing search efforts using starting conditions that have a relatively higher probability of being relevant, thereby reducing a time needed for the search. Additionally, because examples disclosed herein explicitly identify particular NN architecture parameters that are known to be ineffective and/or otherwise cause poor NN performance, such parameters are labeled to aid in machine learning analysis by a network analyzer.

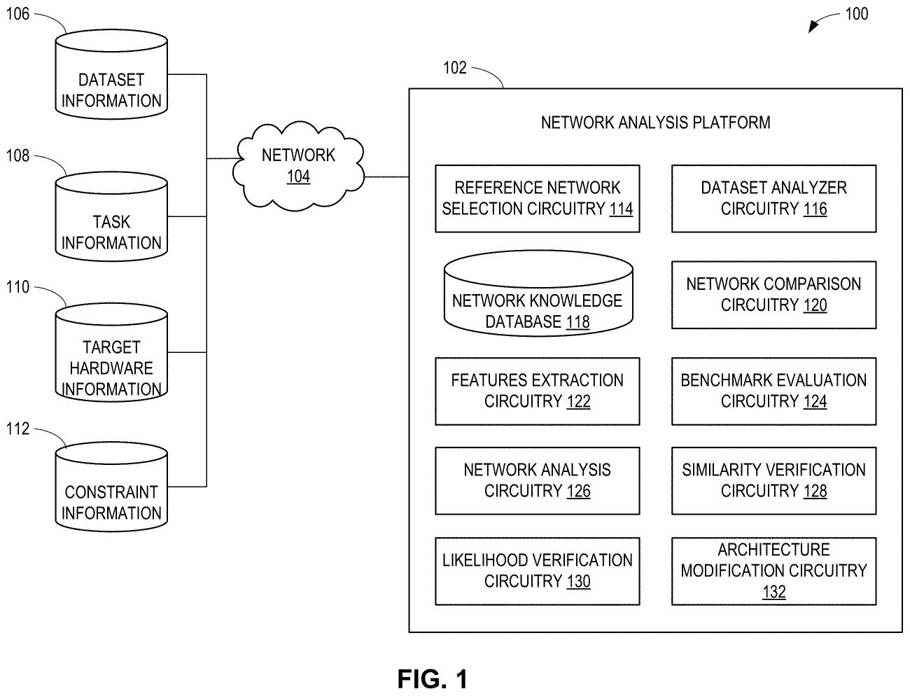

FIG. 1 is an example NAS system 100 to improve neural architecture searches. In the illustrated example of FIG. 1, the NAS system 100 includes an example network analysis platform 102 communicatively connected to an example network 104. The example network 104 is communicatively connected to an example dataset information database 106, example task information 108, example target hardware information 110 and example constraint information 112. While the example network analysis platform 102 is shown as communicatively connected to the example information (e.g., the example dataset information database 106, the example task information 108, the example target hardware information 110, the example constraint information 112) via the example network 104, examples disclosed herein are not limited thereto. For example, the information sources may be directly connected to the example analysis platform 102 without the aid of the example network 104.

The example analysis platform 102 includes example reference network selection circuitry 114, example dataset analyzer circuitry 116, an example network knowledge database 118, example network comparison circuitry 120, example features extraction circuitry 122, example benchmark evaluation circuitry 124, example network analysis circuitry 126, example similarity verification circuitry 128, example likelihood verification circuitry 130 and example architecture modification circuitry 132.

In operation, the example reference network selection circuitry 114 retrieves, receives, accesses and/or otherwise obtains candidate task information, associated task dataset information, target platform characteristics information (e.g., characteristics indicative of a particular target platform type), and in some examples, constraint information. Constraint information includes, but is not limited to particular types of hardware platforms and/or particular metrics (e.g., latency, accuracy), such as metrics to be associated with contractual performance expectations when an architecture is operating on a platform. For instance, if a user is not interested in NNs that have an accuracy value lower than a particular threshold, then that particular value may be used as a constraint. In some examples, the aforementioned information is obtained from a user of the example NAS system 100, which may render one or more user interfaces (UIs) (e.g., a graphical user interface) to accept different types of input from users. In some examples, the NAS system 100 enables users to enter target destination storage locations in which the example dataset information 106 is stored, where the example task information 108 is stored, where the example target hardware information 110 is stored and/or where the example constraint information 112 is stored. In some examples, the NAS system 100 enables user entry of some information, such as information related to the target hardware and/or constraint information. In some examples, the network analysis platform 102 is communicatively connected to computing resources that execute NNs such that the example network analysis platform 102 scans such resources to determine their capabilities (e.g., processor operating frequency) and/or components (e.g., type of processor, amount and/or type of memory, number of processor cores, etc.).

The example dataset analyzer circuitry 116 extracts dataset information from the example dataset information database 106. In some examples, the dataset analyzer circuitry 116 determines any number of characteristics (features) associated with the dataset information to be processed by a network, such as a dataset size and/or a dataset type (e.g., CIFAR-10, ImageNet, a custom dataset, etc.). The example reference network selection circuitry 114 proceeds to select an initial starting point for a neural architecture search in a manner that utilizes available historical information and operational information that the NN is expected to experience. In particular, the example reference network selection circuitry 114 invokes the example similarity verification circuitry 128 to determine whether the network knowledge database 118 includes information corresponding to a prior occurrence of a combination of (a) a same dataset type, (b) a same task type, and (c) a same platform type. To accomplish this determination of a possible prior occurrence of these particular environmental conditions, the example similarity verification circuitry 128 queries the example network knowledge database 118.

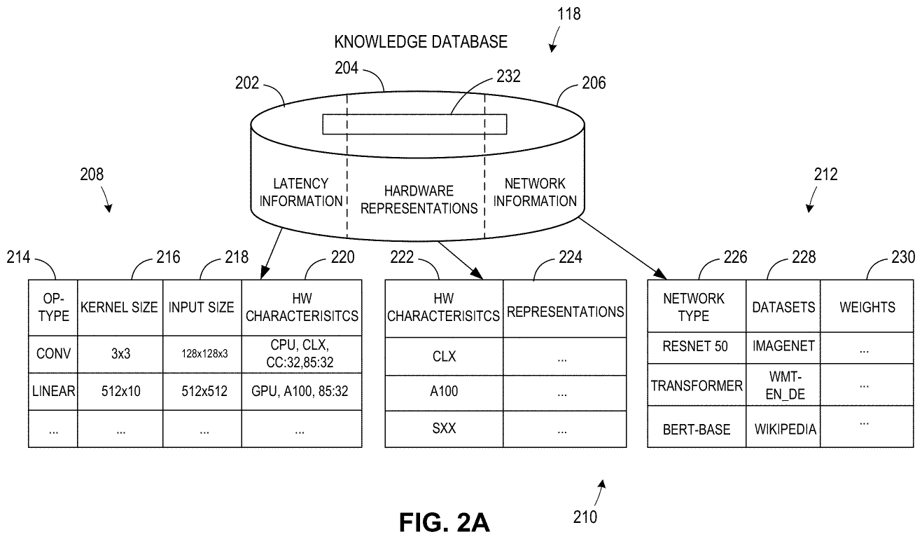

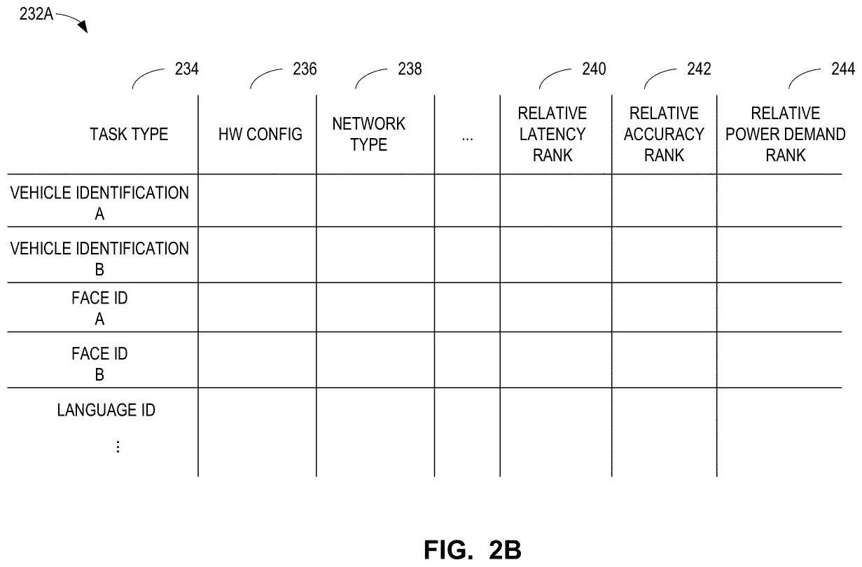

FIG. 2A is a schematic illustration of the example network knowledge database 118. The example network knowledge database 118 is shown in FIG. 1 as part of the example network analysis platform 102, but examples disclosed herein are not limited thereto. In some examples, the network knowledge database 118 may be communicatively connected to the example network analysis platform 102 via the example network 104. In the illustrated example of FIG. 2A, the network knowledge database 118 includes different types of information/data (e.g., network architecture information/data) that is/are relevant to network architectures and how those different network architectures might perform based on particular characteristics. The example network knowledge database 118 includes, but is not limited to latency information 202, hardware representation information 204, network weight information 206, extracted patterns and/or information from a network analyzer (e.g., to facilitate similar NAS searches in the future for expedited search results) and probability distribution information 232.

The illustrated example of FIG. 2A includes an example latency information table 208, an example hardware representation table 210, and an example network information table 212. The example latency information table 208 includes an operation type column 214, a kernel size column 216, an input size column 218, and a hardware characteristics column 220. In the event one or more observations have been made regarding (a) a particular operation type with (b) a particular kernel size and (c) a particular input size that (d) is executed with particular hardware, then the latency information 202 and/or the latency information table 208 may include corresponding latency metric information indicative of performance (e.g., in an additional column(s) of the example latency information table 208).

In some examples, the hardware representation table 210 includes a hardware characteristics column 222 and a corresponding hardware representations column 224. The example hardware representation table 210 includes observed hardware devices that have corresponding performance data, and the example representations column 224 may include details of the observed hardware device. For example, Intel® Cascade Lake (CLX) processors may have different configurations with different numbers of on-board processing cores and cache memory configurations that may be stored in the example representations column 224. In some examples, the information from the hardware representation table 210 is linked to one or more other tables of the example network knowledge database 118 to allow one or more insights to be learned and/or otherwise appreciated. For instance, while the example hardware representation table 210 includes two columns, one or more additional columns may be generated to reveal information corresponding to performance metrics of particular hardware in view of different operation types, different kernel sizes, different input sizes, different network types, etc.

In some examples, the network information table 212 includes a network type column 226, a dataset column 228 and a weights column 230. The example network type column 226 may include any type of observed network types that have been previously executed by particular hardware configurations, particular datasets (e.g., ImageNet), and/or having particular weights. In some examples, the network information table 212 includes one or more additional columns to identify performance metrics for particular configurations.

In some examples, the network knowledge database 118 includes statistical information and/or probability distribution information 232 corresponding to different network configurations and their corresponding performance metrics. In the illustrated example of FIG. 2B, the probability distribution information 232 is shown as a probability distribution information table 232A. The example probability distribution information table 232A includes an example task type column 234, an example hardware configuration column 236, an example network type column 238, an example relative latency rank column 240, an example relative accuracy rank column 242, and an example relative power demand rank column 244. While the example probability distribution information table 232A includes a number of example architecture configuration parameter types (e.g., a hardware configuration 236, a network type configuration 238), examples disclosed herein are not limited thereto and any number of the same may be implemented. Additionally, while the example probability distribution information table 232A includes three (3) example relative rank performance metrics, examples disclosed herein may include any number and/or type of performance metrics.

The example probability distribution information table 232A also includes any number of rows corresponding to particular task types (example column 234), corresponding configuration settings (example columns 236, 238), and corresponding performance metrics (example columns 240, 242, 244). In the event a same task type observation occurs two or more times (e.g., vehicle identification “A” and vehicle identification “B”), then examples disclosed herein provide insight (e.g., information) regarding which particular architecture configuration exhibits particular (e.g., improved) performance metrics. As such, selections for a particular architecture configuration may occur in a more objective manner (e.g., avoiding human discretionary choices), and/or this information may be used in subsequent search algorithms as a preferred starting point, thereby reducing NAS search times.

Returning to the illustrated example of FIG. 1, and considering the example similarity verification circuitry 128 has obtained prior occurrence information of a dataset type, a task type and a platform type, as discussed above, the example similarity verification circuitry 128 determines whether to select one or more architecture configurations from observed prior occurrences (e.g., from the example network knowledge database 118). In some examples, the network knowledge database 118 may not have a sufficient amount of historical data to reveal helpful selections and, in such circumstances, default architecture configuration information may be selected for subsequent search efforts. However, in the event the network knowledge database 118 includes some data corresponding to the task type of interest, or similar task types of interest, then the example likelihood verification circuitry 130 queries the network knowledge database 118 for statistical information. In some examples, the likelihood verification circuitry 130 selects one or more architecture networks that exhibit a relatively highest probability metric value that is related to the task of interest or a task of interest that may be deemed similar. In some examples, the likelihood verification circuitry 130 selects and/or otherwise identifies one or more architecture networks that exhibit a relatively lowest (poorest performing) probability metric value that is related to the task of interest or a task of interest that may be deemed similar. As disclosed above, knowledge of the best and worst performing network architectures and/or network feature combinations is helpful in machine learning analysis when such metrics are labeled.

In some examples, similar tasks are selected for analysis when exact matches are not available. For instance, if the task of interest includes sport car identification, a closest match determined by the example similarity verification circuitry 128 could be task data corresponding to general vehicle identification. In other words, examples disclosed herein enable a search effort to consider relevant architecture characteristics to be used as seeds so that the search effort is more efficient. In some examples, the likelihood verification circuitry 130 selects one or more layer types (e.g., convolution, depth-wise convolution, separable convolution, feed forward linear, etc.) that exhibit a relatively highest probability metric value that is related to the task of interest or a task of interest that may be deemed similar. In some examples, the likelihood verification circuitry 130 selects one or more activation types (e.g., RELU, GeLU, Softmax, etc.) that exhibit a relatively highest probability metric value that is related to the task of interest or a task of interest that may be deemed similar.

Examples disclosed herein also consider whether layer modification (e.g., layer pruning) has occurred in the past and a corresponding effect it may have had on one or more performance metrics. In some examples, the architecture modification circuitry 132 queries the network knowledge database 118 to determine if architecture modification information is available. If so, the architecture modification circuitry 132 applies changes to one or more layers by way of, for example, pruning and/or layer substitution. Again, such modifications may be used to establish a seed or starting point for subsequent search efforts to attempt to converge on a search in a more efficient manner. The example reference network selection circuitry 114 may then forward any number of candidate reference architectures to the example network comparison circuitry 120, as described in further detail below.

In view of the one or more candidate reference architectures to be considered for a search effort, the example network comparison circuitry 120 selects one of them. In some examples, the network comparison circuitry 120 generates a pareto metric and/or pareto graph to determine relative values of two or more co-existing architecture characteristics. Generally speaking, deciding which architectural configuration may be deemed optimal may also require a compromise between individual performance metrics, and the pareto metrics can help determine how the candidate configurations satisfy performance metrics of interest. For example, performance metrics related to accuracy and latency are both typically considered important and/or otherwise valuable when network architecture characteristics are chosen. However, in some circumstances a particular network architecture characteristic combination may perform particularly well with one of those two performance metrics (e.g., accuracy), while performing particularly poorly with another/different one of those two performance metrics (e.g., latency). As such, the example network comparison circuitry 120 generates pareto metrics and/or graphs in view of any number of candidate architecture combinations. While the above-identified example considers generating a pareto metric in view of two architecture characteristics, examples disclosed herein are not limited thereto.

The example network comparison circuitry 120 labels all candidate architecture characteristic combinations based on relative performance, such as their relative performance in view of performing a task in view of accuracy, latency, power consumption, memory bandwidth, etc. In some examples, the network comparison circuitry 120 applies labels indicative of an overall performance value derived as an aggregate of individual performance metrics (e.g., an aggregate of relative accuracy, relative latency and/or relative power consumption). In some examples, performance metrics are categorized and/or otherwise ranked by the example likelihood verification circuitry 130 on an aggregate level, such as a first tier of performance values that perform in a top percentage (e.g., metrics corresponding to an upper threshold) and a second tier of performance values that perform in a bottom percentage (e.g., metrics corresponding to a lower threshold). When such first tier values and bottom tier values are categorized, then their corresponding features are extracted to reveal key guidance on which features, parameters and/or characteristics may cause such first or second tier performance effects. While typical NAS techniques do not consider the granularity of particular features and/or combinations of features as inputs to a network analyzer, examples disclosed herein extract such granularity from historical information related to both past success and past failures with regard to performance metrics.

In some examples, the network comparison circuitry 120 labels candidate architecture characteristic combinations based on pareto metrics, such as particular pareto metrics that do not have values within a lower percentage range. Stated differently, some architecture characteristic combinations exhibit a first performance characteristic (e.g., accuracy) that is within a top threshold percentage (e.g., top 10%) and a second performance characteristic (e.g., latency) that is within a bottom threshold percentage (e.g., bottom 10%). Particular threshold limits may be set to avoid any candidate network architecture combinations when they include a performance metric that resides within a low range (e.g., bottom 20%). In any event, the example network comparison circuitry 120 generates labels for all candidate network architecture combinations, regardless of whether they are considered “best performing” or “worst performing” because both label types are helpful when exploring candidate architectures to ultimately select in a search effort. In particular, knowledge regarding which architecture combinations typically perform poorly when attempting to execute a particular task (e.g., face recognition) is helpful to NAS operating efficiency by avoiding future search attempts for those same architecture combinations.

In the illustrated example of FIG. 2, the features extraction circuitry 122 extracts connectivity information from the candidate architecture combinations. For example, the features extraction circuitry 122 extracts details regarding how many nodes from a first layer are connected to a second layer and its corresponding node count. In some examples, the features extraction circuitry 122 extracts adjacency information.

In the event an input regarding (a) a dataset type, (b) a task type and (c) a target platform type includes corresponding vetted architecture combinations in the example network knowledge database 118, then those particular combinations may be selected when moving forward with deciding which network architecture to use for a target task type of interest. In some examples, the example features extraction circuitry 122 determines that the network knowledge database 118 includes such matching information (e.g., the network knowledge database 118 has a degree of parity with the input). If so, then future NAS efforts may be reduced or eliminated in favor of using the historical network architecture combinations stored in the network knowledge database 118.

However, in the event the features extraction circuitry 122 determines that the network knowledge database 118 does not have parity with the input, or that there is not substantial overlapping parity, then the example benchmark evaluation circuitry 124 is invoked to execute benchmark tests with characteristics that match the desired input. For example, the benchmark evaluation circuitry 124 initiates and/or otherwise instantiates benchmark tests using the same or similar (a) dataset type(s), (b) task type(s) and (c) target platform type(s). In some examples, even when there is parity between the input and the network knowledge database 118, the benchmark evaluation circuitry 124 may instantiate benchmark tests in the event previously stored historical information in the network knowledge database 118 has a threshold age (e.g., the data/information may be considered “stale”). The example benchmark evaluation circuitry 124 calculates updated performance metrics based on the tests and updates the network knowledge database 118 with that new performance metric information (e.g., latency metrics, accuracy metrics, power consumption metrics, multiply-accumulate (MAC) metrics, floating point operations per second (FLOPS), etc.).

Based on benchmark performance results and the architecture characteristics associated therewith and/or based on previously stored performance results and the architecture characteristics associated therewith, the example network comparison circuitry 120 transmits and/or otherwise feeds such seed architecture characteristics and network connectivity information to the example network analysis circuitry 126. In some examples, the network analysis circuitry 126 accepts, receives and/or otherwise retrieves the performance metric information (e.g., latency information, accuracy information, etc.), adjacency information, hardware aware features and/or constraints. The example network analysis circuitry 126, which is sometimes referred to as a network analyzer, extracts any number of patterns using one or more of classical machine learning algorithms, deep neural network trained algorithms (e.g., in a semi-supervised or un-supervised manner), rule-based algorithms, etc. Outputs from the example network analysis circuitry 126 identify candidate architecture characteristics that perform with particular abilities, such as certain architecture characteristics that result in the relatively best performance goals (e.g., least amount of latency with the highest accuracy), or vice-versa. In some examples, the network analysis circuitry 126 generates human readable outputs, such as a sentence stating “For <task 1>, depth-wise separable convolution with a kernel dimension of 3×3 does not perform well on an A100 GPU device.” In some examples, the network analysis circuitry 126 generates one or more visual representations of the output, such as scatterplots, bar-graphs, feature-map plots, etc.

As described above, FIG. 1 is a block diagram of an example NAS system 100 to improve neural architecture searches. The network analysis platform 102 of FIG. 1 may be instantiated (e.g., creating an instance of, bring into being for any length of time, materialize, implement, etc.) by processor circuitry such as a central processing unit executing instructions. Additionally or alternatively, the example network analysis platform 102 of FIG. 1 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 1 may, thus, be instantiated at the same or different times. Some or all of the circuitry may be instantiated, for example, in one or more threads executing concurrently on hardware and/or in series on hardware. Moreover, in some examples, some or all of the circuitry of FIG. 1 may be implemented by microprocessor circuitry executing instructions to implement one or more virtual machines and/or containers.

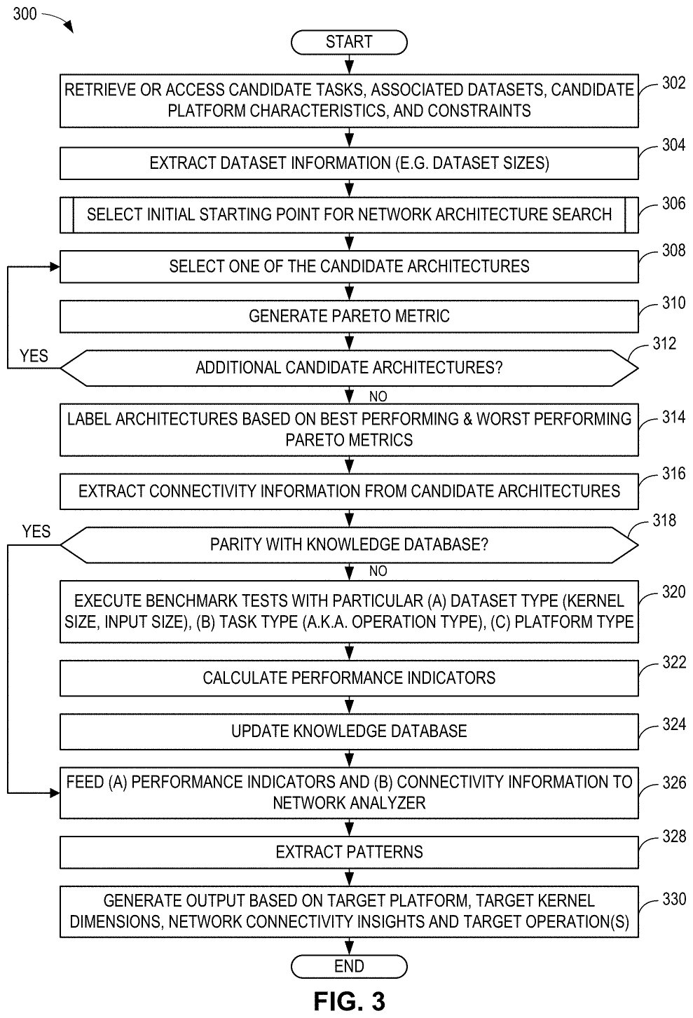

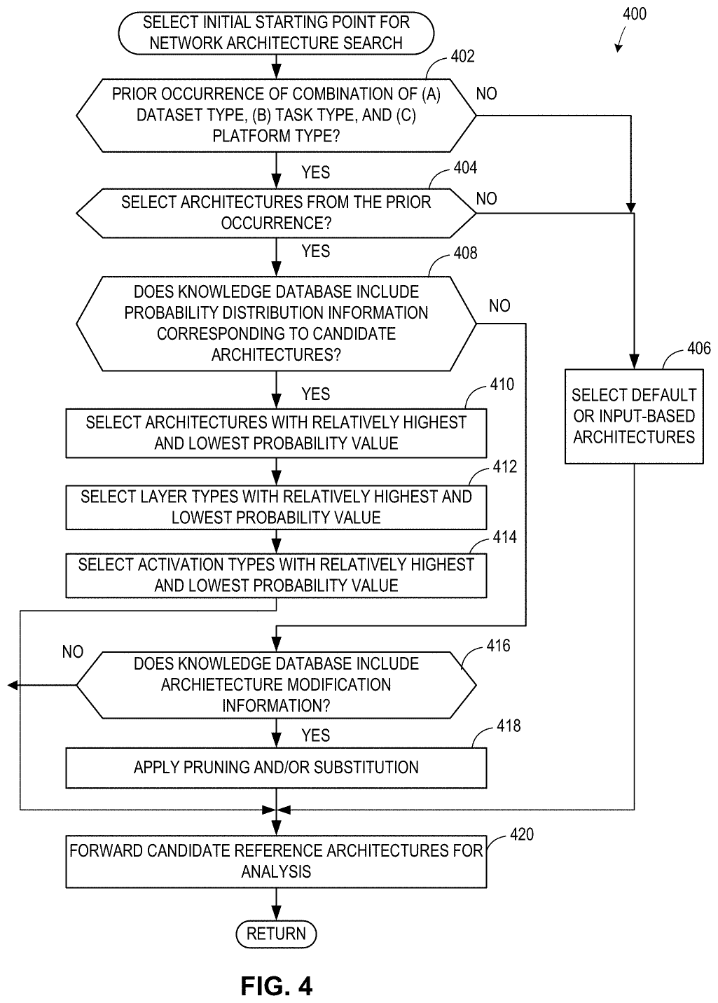

In some examples, the reference network selection circuitry 114, the dataset analyzer circuitry 116, the network comparison circuitry 120, the features extraction circuitry 122, the benchmark evaluation circuitry 124, the network analysis circuitry 126, the similarity verification circuitry 128, the likelihood verification circuitry 130, the architecture modification circuitry 132 and/or the network analysis platform 102 is instantiated by processor circuitry executing instructions and/or configured to perform operations such as those represented by the flowcharts of FIGS. 3 and 4.

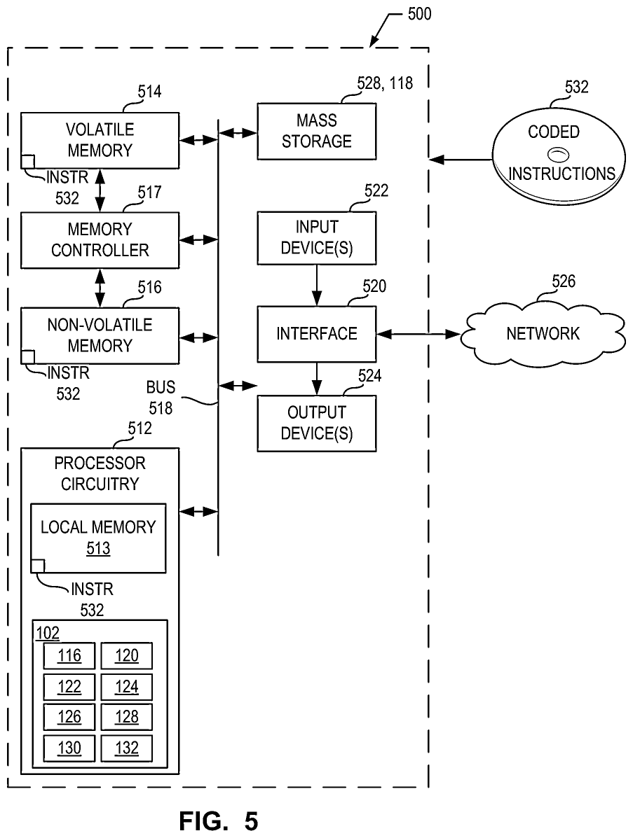

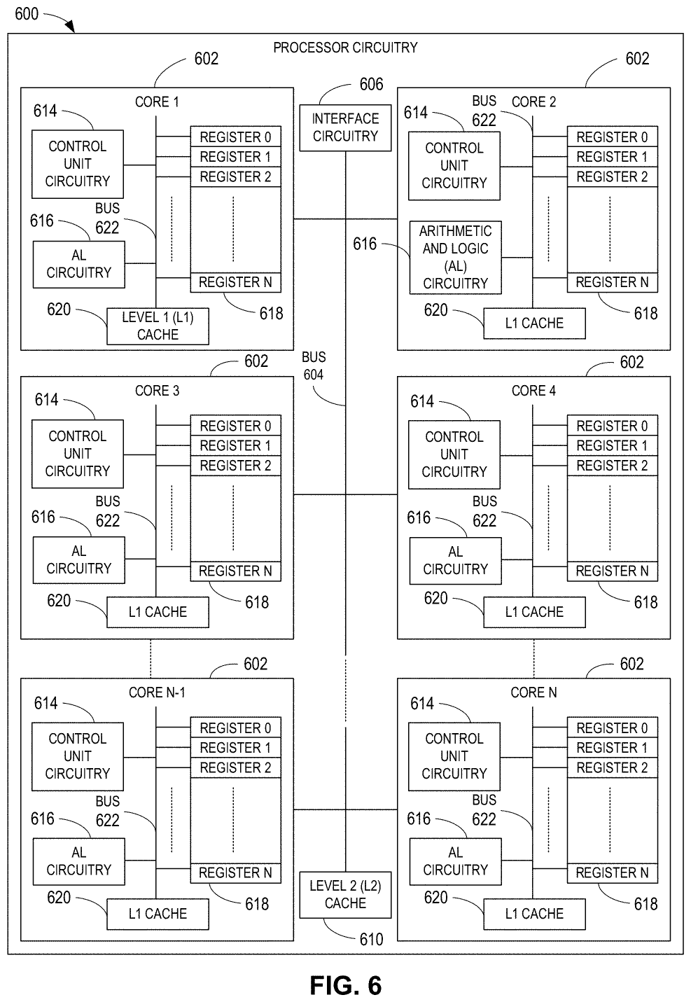

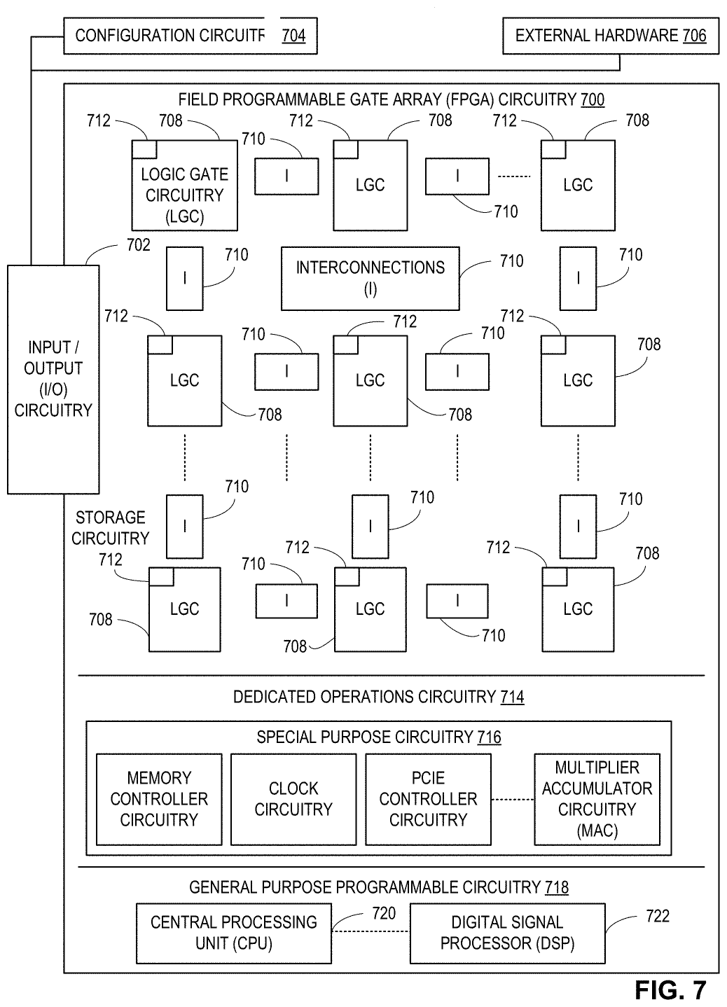

In some examples, the apparatus includes means for reference network selection, means for dataset analysis, means for network comparison, means for feature extraction, means for benchmark evaluation, means for network analysis, means for similarity verification, means for likelihood verification, and means for architecture modification. For example, the means for reference network selection, the means for dataset analysis, the means for network comparison, the means for feature extraction, the means for benchmark evaluation, the means for network analysis, the means for similarity verification, the means for likelihood verification, and the means for architecture modification may be implemented by respective ones of the reference network selection circuitry 114, the dataset analyzer circuitry 116, the network comparison circuitry 120, the features extraction circuitry 122, the benchmark evaluation circuitry 124, the network analysis circuitry 126, the similarity verification circuitry 128, the likelihood verification circuitry 130, and the architecture modification circuitry 132. In some examples, the aforementioned may be instantiated by processor circuitry such as the example processor circuitry 512 of FIG. 5. For instance, the aforementioned circuitry may be instantiated by the example microprocessor 600 of FIG. 6 executing machine executable instructions such as those implemented by at least the blocks of FIGS. 3 and 4. In some examples, the aforementioned circuitry may be instantiated by hardware logic circuitry, which may be implemented by an ASIC, XPU, or the FPGA circuitry 700 of FIG. 7 structured to perform operations corresponding to the machine readable instructions. Additionally or alternatively, the aforementioned circuitry may be instantiated by any other combination of hardware, software, and/or firmware. For example, the aforementioned circuitry may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the example network analysis platform 102 of FIG. 1 is illustrated in FIGS. 1, 2 and 2A, one or more of the elements, processes, and/or devices illustrated in FIG. 1 may be combined, divided, re-arranged, omitted, eliminated, and/or implemented in any other way. Further, the example reference network selection circuitry 114, the example dataset analyzer circuitry 116, the example network comparison circuitry 120, the example features extraction circuitry 122, the example benchmark evaluation circuitry 124, the example network analysis circuitry 126, the example similarity verification circuitry 128, the example likelihood verification circuitry 130, the example architecture modification circuitry 132 and/or, more generally, the example network analysis platform 102 of FIG. 1, may be implemented by hardware alone or by hardware in combination with software and/or firmware. Thus, for example, any of the example reference network selection circuitry 114, the example dataset analyzer circuitry 116, the example network comparison circuitry 120, the example features extraction circuitry 122, the example benchmark evaluation circuitry 124, the example network analysis circuitry 126, the example similarity verification circuitry 128, the example likelihood verification circuitry 130, the example architecture modification circuitry 132 and/or, more generally, the example network analysis platform 102 of FIG. 1, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example network analysis platform 102 of FIG. 1 may include one or more elements, processes, and/or devices in addition to, or instead of, those illustrated in FIGS. 1, 2A and 2B, and/or may include more than one of any or all of the illustrated elements, processes and devices.

Flowcharts representative of example machine readable instructions, which may be executed to configure processor circuitry to implement the network analysis platform 102 of FIG. 1, are shown in FIGS. 3 and 4. The machine readable instructions may be one or more executable programs or portion(s) of an executable program for execution by processor circuitry, such as the processor circuitry 512 shown in the example processor platform 500 discussed below in connection with FIG. 5 and/or the example processor circuitry discussed below in connection with FIGS. 6 and/or 7. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 3 and 4, many other methods of implementing the example network analysis platform 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3 and 4 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a,” “an,” “first,” “second,” etc.) do not exclude a plurality. The term “a” or “an” object, as used herein, refers to one or more of that object. The terms “a” (or “an”), “one or more,” and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed and/or instantiated by processor circuitry to improve neural architecture searches. The machine readable instructions and/or the operations 300 of FIG. 3 begin at block 302, at which the example reference network selection circuitry 114 retrieves, receives, accesses and/or otherwise obtains candidate task information, associated task dataset information, target platform characteristics information, and in some examples, constraint information. The example dataset analyzer circuitry 116 extracts dataset information from the example dataset information database 106 (block 304), and the example reference network selection circuitry 114 selects an initial starting point for a neural architecture search in a manner that utilizes available historical information and operational information that the NN is expected to experience (block 306).

FIG. 4 includes additional detail corresponding to block 306 of FIG. 3. In the illustrated example of FIG. 4, the similarity verification circuitry 128 determines whether a prior occurrence of a combination of (a) a same dataset type, (b) a same task type, and (c) a same platform type has occurred (block 402). If so, the similarity verification circuitry 128 selects one or more architectures that have been observed on a prior occurrence (block 404) or selects default and/or input-based (e.g., user input) architectures (block 406). For those circumstances where the prior occurrences are selected (block 404), the example likelihood verification circuitry 130 further improves the efficiency and success of a NAS search by querying the network knowledge database 118 for statistical information (e.g., probability distribution information) corresponding to the candidate architectures (block 408). As discussed above, selecting architectures that have a relatively higher probability of being relevant in the search effort will ultimately reduce the search duration and improve the accuracy thereof.

In the event the example network knowledge database 118 includes probability distribution information (block 408), the example likelihood verification circuitry 130 selects a threshold number of architectures that exhibit a relatively highest probability value (e.g., a probability value corresponding to a highest expected performance metric of interest) (block 410). As disclosed above, the example likelihood verification circuitry 130 selects architectures that exhibit a relatively lowest probability value (e.g., a probability value corresponding to a lowest expected performance metric of interest) so that machine learning techniques can more quickly converge on desired network architectures that ultimately perform the best. Additionally, the likelihood verification circuitry 130 selects one or more layer types (e.g., convolution, depth-wise convolution, separable convolution, feed forward linear, etc.) that exhibit a relatively highest probability metric value that is related to the task of interest or a task of interest that may be deemed similar (block 412) (e.g., similar to a target task of interest that prompted the NAS effort). Further, the example likelihood verification circuitry 130 selects one or more activation types (e.g., RELU, GeLU, Softmax, etc.) that exhibit a relatively highest probability metric value that is related to the task of interest or a task of interest that may be deemed similar (block 414).

The example architecture modification circuitry 132 determines whether the network knowledge database 118 includes architectural modification information (block 416), such as pruning modifications. If so, the architecture modification circuitry 132 applies changes to one or more layers by way of, for example, pruning and/or layer substitution (block 418). The example reference network selection circuitry 114 forwards any number of candidate reference architectures to the example network comparison circuitry 120 (block 420), and control advances to block 308 of FIG. 3.

Returning to the illustrated example of FIG. 3, the example network comparison circuitry 120 selects one of the candidate architectures (block 308). Stated differently, the candidate architectures to be considered have now gone through a degree of vetting or further consideration in view of information (e.g., clues) that traditional NAS efforts do not consider prior to instantiating computationally intense and lengthy search efforts. The example network comparison circuitry 120 generates a pareto metric and/or pareto graph to determine relative values of two or more co-existing architecture characteristics (block 310), and if there are additional architectures to consider (block 312), control returns to block 308. In some examples, the network comparison circuitry 120 generates one or more pareto metric and/or pareto graph as an output of a particular NAS solution. Otherwise the example network comparison circuitry 120 labels all candidate architecture characteristic combinations based on relative performance (block 314), such as their relative performance in view of performing a task in view of accuracy, latency, power consumption, etc. As described above, labeling is applied for both the best performing (e.g., architectures that exhibit the relative highest performance metrics) and the worst performing (e.g., architectures that exhibit the relative lowest performance metrics) so that future machine learning modeling can more quickly converge on relevant solutions.

The example features extraction circuitry 122 extracts connectivity information from the candidate architecture combinations (block 316), and determines whether there is a need to perform benchmark testing (block 318). For example, if the network knowledge database 118 does not have performance metrics associated with candidate architectures of interest (in which the performance metrics will be helpful in machine learning analysis of the candidate architectures), then the example benchmark evaluation circuitry 124 is invoked to execute benchmark tests (block 320) and calculate performance indicators (block 322). The benchmark evaluation circuitry 124 updates the network knowledge database 118 with the calculated indicators (block 324).

The example network comparison circuitry 120 transmits and/or otherwise feeds such seed architecture characteristics and network connectivity information to the example network analysis circuitry 126 (block 326), and the example network analysis circuitry 126 extracts any number of patterns using one or more of classical machine learning algorithms, deep neural network trained algorithms (e.g., in a semi-supervised or un-supervised manner), rule-based algorithms, etc. (block 328). The network comparison circuitry 120 (or in some examples the network analysis circuitry 126) generates outputs corresponding to candidate architecture characteristics that perform with particular abilities (block 330), such as certain architecture characteristics that result in the relatively best performance goals (e.g., least amount of latency with the highest accuracy), or vice-versa.

FIG. 5 is a block diagram of an example processor platform 500 structured to execute and/or instantiate the machine readable instructions and/or the operations of FIGS. 3 and 4 to implement the network analysis platform 102 of FIG. 1. The processor platform 500 can be, for example, a server, a personal computer, a workstation, a self-learning machine (e.g., a neural network), a mobile device (e.g., a cell phone, a smart phone, a tablet such as an iPad™), an Internet appliance, a gaming console, a set top box, a headset (e.g., an augmented reality (AR) headset, a virtual reality (VR) headset, etc.) or other wearable device, or any other type of computing device.

The processor platform 500 of the illustrated example includes processor circuitry 512. The processor circuitry 512 of the illustrated example is hardware. For example, the processor circuitry 512 can be implemented by one or more integrated circuits, logic circuits, FPGAs, microprocessors, CPUs, GPUs, DSPs, and/or microcontrollers from any desired family or manufacturer. The processor circuitry 512 may be implemented by one or more semiconductor based (e.g., silicon based) devices. In this example, the processor circuitry 512 implements the example reference network selection circuitry 114, the example dataset analyzer circuitry 116, the example network comparison circuitry 120, the example features extraction circuitry 122, the example benchmark evaluation circuitry 124, the example network analysis circuitry 126, the example similarity verification circuitry 128, the example likelihood verification circuitry 130, the example architecture modification circuitry 132 and/or, more generally, the example network analysis platform 102 of FIG. 1.

The processor circuitry 512 of the illustrated example includes a local memory 513 (e.g., a cache, registers, etc.). The processor circuitry 512 of the illustrated example is in communication with a main memory including a volatile memory 514 and a non-volatile memory 516 by a bus 518. The volatile memory 514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 516 may be implemented by flash memory and/or any other desired type of memory device. Access to the main memory 514, 516 of the illustrated example is controlled by a memory controller 517.

The processor platform 500 of the illustrated example also includes interface circuitry 520. The interface circuitry 520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 522 are connected to the interface circuitry 520. The input device(s) 522 permit(s) a user to enter data and/or commands into the processor circuitry 512. The input device(s) 522 can be implemented by, for example, an audio sensor, a microphone, a camera (still or video), a keyboard, a button, a mouse, a touchscreen, a track-pad, a trackball, an isopoint device, and/or a voice recognition system.

One or more output devices 524 are also connected to the interface circuitry 520 of the illustrated example. The output device(s) 524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 520 of the illustrated example, thus, typically includes a graphics driver card, a graphics driver chip, and/or graphics processor circuitry such as a GPU.

The interface circuitry 520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 526. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 500 of the illustrated example also includes one or more mass storage devices 528 to store software and/or data. Examples of such mass storage devices 528 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 532, which may be implemented by the machine readable instructions of FIGS. 3 and 4, may be stored in the mass storage device 528, in the volatile memory 514, in the non-volatile memory 516, and/or on a removable non-transitory computer readable storage medium such as a CD or DVD.

FIG. 6 is a block diagram of an example implementation of the processor circuitry 512 of FIG. 5. In this example, the processor circuitry 512 of FIG. 5 is implemented by a microprocessor 600. For example, the microprocessor 600 may be a general purpose microprocessor (e.g., general purpose microprocessor circuitry). The microprocessor 600 executes some or all of the machine readable instructions of the flowcharts of FIGS. 3 and 4 to effectively instantiate the circuitry of FIG. 1 as logic circuits to perform the operations corresponding to those machine readable instructions. In some such examples, the circuitry of FIG. 1 is instantiated by the hardware circuits of the microprocessor 600 in combination with the instructions. For example, the microprocessor 600 may be implemented by multi-core hardware circuitry such as a CPU, a DSP, a GPU, an XPU, etc. Although it may include any number of example cores 602 (e.g., 1 core), the microprocessor 600 of this example is a multi-core semiconductor device including N cores. The cores 602 of the microprocessor 600 may operate independently or may cooperate to execute machine readable instructions. For example, machine code corresponding to a firmware program, an embedded software program, or a software program may be executed by one of the cores 602 or may be executed by multiple ones of the cores 602 at the same or different times. In some examples, the machine code corresponding to the firmware program, the embedded software program, or the software program is split into threads and executed in parallel by two or more of the cores 602. The software program may correspond to a portion or all of the machine readable instructions and/or operations represented by the flowcharts of FIGS. 3 and 4.

The cores 602 may communicate by a first example bus 604. In some examples, the first bus 604 may be implemented by a communication bus to effectuate communication associated with one(s) of the cores 602. For example, the first bus 604 may be implemented by at least one of an Inter-Integrated Circuit (I2C) bus, a Serial Peripheral Interface (SPI) bus, a PCI bus, or a PCIe bus. Additionally or alternatively, the first bus 604 may be implemented by any other type of computing or electrical bus. The cores 602 may obtain data, instructions, and/or signals from one or more external devices by example interface circuitry 606. The cores 602 may output data, instructions, and/or signals to the one or more external devices by the interface circuitry 606. Although the cores 602 of this example include example local memory 620 (e.g., Level 1 (L1) cache that may be split into an L1 data cache and an L1 instruction cache), the microprocessor 600 also includes example shared memory 610 that may be shared by the cores (e.g., Level 2 (L2 cache)) for high-speed access to data and/or instructions. Data and/or instructions may be transferred (e.g., shared) by writing to and/or reading from the shared memory 610. The local memory 620 of each of the cores 602 and the shared memory 610 may be part of a hierarchy of storage devices including multiple levels of cache memory and the main memory (e.g., the main memory 514, 516 of FIG. 5). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 602 may be referred to as a CPU, DSP, GPU, etc., or any other type of hardware circuitry. Each core 602 includes control unit circuitry 614, arithmetic and logic (AL) circuitry (sometimes referred to as an ALU) 616, a plurality of registers 618, the local memory 620, and a second example bus 622. Other structures may be present. For example, each core 602 may include vector unit circuitry, single instruction multiple data (SIMD) unit circuitry, load/store unit (LSU) circuitry, branch/jump unit circuitry, floating-point unit (FPU) circuitry, etc. The control unit circuitry 614 includes semiconductor-based circuits structured to control (e.g., coordinate) data movement within the corresponding core 602. The AL circuitry 616 includes semiconductor-based circuits structured to perform one or more mathematic and/or logic operations on the data within the corresponding core 602. The AL circuitry 616 of some examples performs integer based operations. In other examples, the AL circuitry 616 also performs floating point operations. In yet other examples, the AL circuitry 616 may include first AL circuitry that performs integer based operations and second AL circuitry that performs floating point operations. In some examples, the AL circuitry 616 may be referred to as an Arithmetic Logic Unit (ALU). The registers 618 are semiconductor-based structures to store data and/or instructions such as results of one or more of the operations performed by the AL circuitry 616 of the corresponding core 602. For example, the registers 618 may include vector register(s), SIMD register(s), general purpose register(s), flag register(s), segment register(s), machine specific register(s), instruction pointer register(s), control register(s), debug register(s), memory management register(s), machine check register(s), etc. The registers 618 may be arranged in a bank as shown in FIG. 6. Alternatively, the registers 618 may be organized in any other arrangement, format, or structure including distributed throughout the core 602 to shorten access time. The second bus 622 may be implemented by at least one of an I2C bus, a SPI bus, a PCI bus, or a PCIe bus

Each core 602 and/or, more generally, the microprocessor 600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 600 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 7 is a block diagram of another example implementation of the processor circuitry 512 of FIG. 5. In this example, the processor circuitry 512 is implemented by FPGA circuitry 700. For example, the FPGA circuitry 700 may be implemented by an FPGA. The FPGA circuitry 700 can be used, for example, to perform operations that could otherwise be performed by the example microprocessor 600 of FIG. 6 executing corresponding machine readable instructions. However, once configured, the FPGA circuitry 700 instantiates the machine readable instructions in hardware and, thus, can often execute the operations faster than they could be performed by a general purpose microprocessor executing the corresponding software.

More specifically, in contrast to the microprocessor 600 of FIG. 6 described above (which is a general purpose device that may be programmed to execute some or all of the machine readable instructions represented by the flowcharts of FIGS. 3 and 4 but whose interconnections and logic circuitry are fixed once fabricated), the FPGA circuitry 700 of the example of FIG. 7 includes interconnections and logic circuitry that may be configured and/or interconnected in different ways after fabrication to instantiate, for example, some or all of the machine readable instructions represented by the flowcharts of FIGS. 3 and 4. In particular, the FPGA circuitry 700 may be thought of as an array of logic gates, interconnections, and switches. The switches can be programmed to change how the logic gates are interconnected by the interconnections, effectively forming one or more dedicated logic circuits (unless and until the FPGA circuitry 700 is reprogrammed). The configured logic circuits enable the logic gates to cooperate in different ways to perform different operations on data received by input circuitry. Those operations may correspond to some or all of the software represented by the flowcharts of FIGS. 3 and 4. As such, the FPGA circuitry 700 may be structured to effectively instantiate some or all of the machine readable instructions of the flowcharts of FIGS. 3 and 4 as dedicated logic circuits to perform the operations corresponding to those software instructions in a dedicated manner analogous to an ASIC. Therefore, the FPGA circuitry 700 may perform the operations corresponding to the some or all of the machine readable instructions of FIGS. 3 and 4 faster than the general purpose microprocessor can execute the same.

In the example of FIG. 7, the FPGA circuitry 700 is structured to be programmed (and/or reprogrammed one or more times) by an end user by a hardware description language (HDL) such as Verilog. The FPGA circuitry 700 of FIG. 7, includes example input/output (I/O) circuitry 702 to obtain and/or output data to/from example configuration circuitry 704 and/or external hardware 706. For example, the configuration circuitry 704 may be implemented by interface circuitry that may obtain machine readable instructions to configure the FPGA circuitry 700, or portion(s) thereof. In some such examples, the configuration circuitry 704 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 706 may be implemented by external hardware circuitry. For example, the external hardware 706 may be implemented by the microprocessor 600 of FIG. 6. The FPGA circuitry 700 also includes an array of example logic gate circuitry 708, a plurality of example configurable interconnections 710, and example storage circuitry 712. The logic gate circuitry 708 and the configurable interconnections 710 are configurable to instantiate one or more operations that may correspond to at least some of the machine readable instructions of FIGS. 3 and 4 and/or other desired operations. The logic gate circuitry 708 shown in FIG. 7 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 708 to enable configuration of the electrical structures and/or the logic gates to form circuits to perform desired operations. The logic gate circuitry 708 may include other electrical structures such as look-up tables (LUTs), registers (e.g., flip-flops or latches), multiplexers, etc.

The configurable interconnections 710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 708 to program desired logic circuits.

The storage circuitry 712 of the illustrated example is structured to store result(s) of the one or more of the operations performed by corresponding logic gates. The storage circuitry 712 may be implemented by registers or the like. In the illustrated example, the storage circuitry 712 is distributed amongst the logic gate circuitry 708 to facilitate access and increase execution speed.

The example FPGA circuitry 700 of FIG. 7 also includes example Dedicated Operations Circuitry 714. In this example, the Dedicated Operations Circuitry 714 includes special purpose circuitry 716 that may be invoked to implement commonly used functions to avoid the need to program those functions in the field. Examples of such special purpose circuitry 716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 700 may also include example general purpose programmable circuitry 718 such as an example CPU 720 and/or an example DSP 722. Other general purpose programmable circuitry 718 may additionally or alternatively be present such as a GPU, an XPU, etc., that can be programmed to perform other operations.

Although FIGS. 6 and 7 illustrate two example implementations of the processor circuitry 512 of FIG. 5, many other approaches are contemplated. For example, as mentioned above, modern FPGA circuitry may include an on-board CPU, such as one or more of the example CPU 720 of FIG. 7. Therefore, the processor circuitry 512 of FIG. 5 may additionally be implemented by combining the example microprocessor 600 of FIG. 6 and the example FPGA circuitry 700 of FIG. 7. In some such hybrid examples, a first portion of the machine readable instructions represented by the flowcharts of FIGS. 3 and 4 may be executed by one or more of the cores 602 of FIG. 6, a second portion of the machine readable instructions represented by the flowcharts of FIGS. 3 and 4 may be executed by the FPGA circuitry 700 of FIG. 7, and/or a third portion of the machine readable instructions represented by the flowcharts of FIGS. 3 and 4 may be executed by an ASIC. It should be understood that some or all of the circuitry of FIG. 1 may, thus, be instantiated at the same or different times. Some or all of the circuitry may be instantiated, for example, in one or more threads executing concurrently and/or in series. Moreover, in some examples, some or all of the circuitry of FIG. 1 may be implemented within one or more virtual machines and/or containers executing on the microprocessor.

In some examples, the processor circuitry 512 of FIG. 5 may be in one or more packages. For example, the microprocessor 600 of FIG. 6 and/or the FPGA circuitry 700 of FIG. 7 may be in one or more packages. In some examples, an XPU may be implemented by the processor circuitry 512 of FIG. 5, which may be in one or more packages. For example, the XPU may include a CPU in one package, a DSP in another package, a GPU in yet another package, and an FPGA in still yet another package.

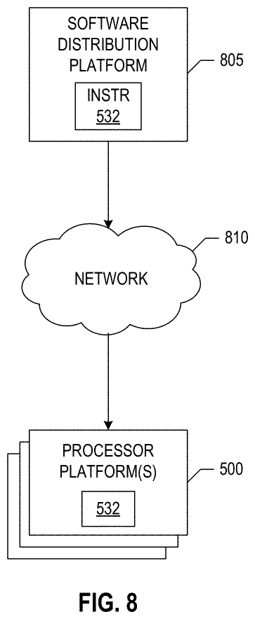

A block diagram illustrating an example software distribution platform 805 to distribute software such as the example machine readable instructions 532 of FIG. 5 to hardware devices owned and/or operated by third parties is illustrated in FIG. 8. The example software distribution platform 805 may be implemented by any computer server, data facility, cloud service, etc., capable of storing and transmitting software to other computing devices. The third parties may be customers of the entity owning and/or operating the software distribution platform 805. For example, the entity that owns and/or operates the software distribution platform 805 may be a developer, a seller, and/or a licensor of software such as the example machine readable instructions 532 of FIG. 5. The third parties may be consumers, users, retailers, OEMs, etc., who purchase and/or license the software for use and/or re-sale and/or sub-licensing. In the illustrated example, the software distribution platform 805 includes one or more servers and one or more storage devices. The storage devices store the machine readable instructions 532, which may correspond to the example machine readable instructions of FIGS. 3 and 4, as described above. The one or more servers of the example software distribution platform 805 are in communication with an example network 810, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 532 from the software distribution platform 805. For example, the software, which may correspond to the example machine readable instructions of FIGS. 3 and 4, may be downloaded to the example processor platform 500, which is to execute the machine readable instructions 532 to implement examples disclosed herein. In some examples, one or more servers of the software distribution platform 805 periodically offer, transmit, and/or force updates to the software (e.g., the example machine readable instructions 532 of FIG. 5) to ensure improvements, patches, updates, etc., are distributed and applied to the software at the end user devices.

From the foregoing, it will be appreciated that example systems, methods, apparatus, and articles of manufacture have been disclosed that improve the efficiency of performing neural architecture searches. Examples disclosed herein consider a lower-level degree of granularity for inputs of a network analyzer, such that particular features of a candidate architecture are used in view of their corresponding performance effects. Additionally, the granular features are labeled as such so that machine learning and/or artificial intelligence systems can converge to optimum architectures faster.

Example methods, apparatus, systems, and articles of manufacture to improve neural architecture searches are disclosed herein. Further examples and combinations thereof include the following:

Example 1 includes an apparatus including interface circuitry to obtain target task information, and processor circuitry including one or more of at least one of a central processor unit, a graphics processor unit, or a digital signal processor, the at least one of the central processor unit, the graphics processor unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus, a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations, or Application Specific Integrated Circuitry (ASIC) including logic gate circuitry to perform one or more third operations, the processor circuitry to perform at least one of the first operations, the second operations, or the third operations to instantiate similarity verification circuitry to identify candidate networks based on a combination of a target platform type, a target workload type to be executed by the target platform type, and historical benchmark metrics corresponding to the candidate networks, wherein the candidate networks are associated with performance metrics, likelihood verification circuitry to categorize (a) a first set of the candidate networks based on a first one of the performance metrics corresponding to first tier values, and (b) a second set of the candidate networks based on a second one of the performance metrics corresponding to second tier values, and extract first features corresponding to the first set of the candidate networks and extract second features corresponding to the second set of the candidate networks, and network analysis circuitry to perform network analysis by providing the first features and the second features to a network analyzer to identify particular ones of the candidate networks.

Example 2 includes the apparatus as defined in example 1, wherein the likelihood verification circuitry is to identify (a) the first tier values as performance metrics corresponding to an upper threshold and (b) the second tier values as performance metrics corresponding to a lower threshold.

Example 3 includes the apparatus as defined in example 1, further including benchmark evaluation circuitry to initiate benchmarking tests corresponding to operation information extracted from the candidate networks.

Example 4 includes the apparatus as defined in example 3, wherein the benchmark evaluation circuitry is to initiate the benchmarking tests corresponding to the target platform type to determine third performance metrics.

Example 5 includes the apparatus as defined in example 4, wherein the third performance metrics include at least one of latency, accuracy, power consumption or memory bandwidth.

Example 6 includes the apparatus as defined in example 3, wherein the operation information corresponds to at least one of an operation type, a kernel size or an input size.

Example 7 includes the apparatus as defined in example 1, wherein the first and second features include at least one of network adjacency features, layer connection information, or network graph information.

Example 8 includes the apparatus as defined in example 1, further including architecture modification circuitry to query a network knowledge database for prior modification information corresponding to the candidate networks.

Example 9 includes the apparatus as defined in example 8, wherein the architecture modification circuitry is to establish a starting search point by applying changes to the candidate networks.

Example 10 includes an apparatus to identify candidate networks, including at least one memory, machine readable instructions, and processor circuitry to at least one of instantiate or execute the machine readable instructions to determine candidate networks corresponding to a combination of target platform characteristics, workload characteristics to be executed by a target platform, and historical benchmark metrics characteristics associated with the candidate networks, wherein the candidate networks are associated with performance metrics, categorize (a) a first set of the candidate networks based on first values, and (b) a second set of the candidate networks based on second values, identify (a) first features associated with the first set of the candidate networks and (b) second features associated with the second set of the candidate networks, and feed a network analyzer with the first and second features to determine one or more of the candidate networks to be executed with the target platform.

Example 11 includes the apparatus as defined in example 10, wherein the processor circuitry is to cause identification of (a) performance metrics corresponding to an upper threshold as the first values, and (b) performance metrics corresponding to a lower threshold as the second values.

Example 12 includes the apparatus as defined in example 10, wherein the processor circuitry is to initiate benchmarking tests corresponding to operation information extracted from the candidate networks.

Example 13 includes the apparatus as defined in example 12, wherein the processor circuitry is to initiate the benchmarking tests corresponding to the target platform to determine third performance metrics.

Example 14 includes the apparatus as defined in example 13, wherein the processor circuitry is to identify the third performance metrics as at least one of latency, accuracy, power consumption or memory bandwidth.

Example 15 includes the apparatus as defined in example 12, wherein the processor circuitry is to identify operation information as at least one of an operation type, a kernel size or an input size.

Example 16 includes the apparatus as defined in example 10, wherein the first and second features include at least one of network adjacency features, layer connection information, or network graph information.

Example 17 includes the apparatus as defined in example 10, wherein the processor circuitry is to query a network knowledge database for prior modification information corresponding to the candidate networks.

Example 18 includes the apparatus as defined in example 17, wherein the processor circuitry is to initiate a starting search point by applying changes to the candidate networks.

Example 19 includes a non-transitory machine readable storage medium including instructions that, when executed, cause processor circuitry to at least determine candidate networks corresponding to a combination of target platform characteristics, workload characteristics to be executed by a target platform, and historical benchmark metrics characteristics associated with the candidate networks, wherein the candidate networks are associated with performance metrics, categorize (a) a first set of the candidate networks based on first tier values, and (b) a second set of the candidate networks based on second tier values, identify (a) first features associated with the first set of the candidate networks and (b) second features associated with the second set of the candidate networks, and feed a network analyzer with the first and second features to determine one or more of the candidate networks to be executed with the target platform.

Example 20 includes the non-transitory machine readable storage medium as defined in example 19, wherein the instructions, when executed, cause the processor circuitry to identify (a) performance metrics corresponding to an upper threshold as the first tier values, and (b) performance metrics corresponding to a lower threshold as the second tier values.

Example 21 includes the non-transitory machine readable storage medium as defined in example 19, wherein the instructions, when executed, cause the processor circuitry to initiate benchmarking tests corresponding to operation information extracted from the candidate networks.

Example 22 includes the non-transitory machine readable storage medium as defined in example 21, wherein the instructions, when executed, cause the processor circuitry to initiate the benchmarking tests corresponding to the target platform to determine third performance metrics.

Example 23 includes the non-transitory machine readable storage medium as defined in example 22, wherein the instructions, when executed, cause the processor circuitry to identify the third performance metrics as at least one of latency, accuracy, power consumption or memory bandwidth.

Example 24 includes the non-transitory machine readable storage medium as defined in example 21, wherein the instructions, when executed, cause the processor circuitry to identify operation information as at least one of an operation type, a kernel size or an input size.

Example 25 includes the non-transitory machine readable storage medium as defined in example 19, wherein the instructions, when executed, cause the processor circuitry to identify the first and the second features as at least one of network adjacency features, layer connection information, or network graph information.

Example 26 includes the non-transitory machine readable storage medium as defined in example 19, wherein the instructions, when executed, cause the processor circuitry to query a network knowledge database for prior modification information corresponding to the candidate networks.

Example 27 includes the non-transitory machine readable storage medium as defined in example 26, wherein the instructions, when executed, cause the processor circuitry to initiate a starting search point by applying changes to the candidate networks.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus comprising:
interface circuitry to obtain target task information; and
processor circuitry including one or more of:
at least one of a central processor unit, a graphics processor unit, or a digital signal processor, the at least one of the central processor unit, the graphics processor unit, or the digital signal processor having control circuitry to control data movement within the processor circuitry, arithmetic and logic circuitry to perform one or more first operations corresponding to instructions, and one or more registers to store a result of the one or more first operations, the instructions in the apparatus;
a Field Programmable Gate Array (FPGA), the FPGA including logic gate circuitry, a plurality of configurable interconnections, and storage circuitry, the logic gate circuitry and the plurality of the configurable interconnections to perform one or more second operations, the storage circuitry to store a result of the one or more second operations; or
Application Specific Integrated Circuitry (ASIC) including logic gate circuitry to perform one or more third operations;
the processor circuitry to perform at least one of the first operations, the second operations, or the third operations to instantiate:
similarity verification circuitry to identify candidate networks based on a combination of a target platform type, a target workload type to be executed by the target platform type, and historical benchmark metrics corresponding to the candidate networks, wherein the candidate networks are associated with performance metrics;
likelihood verification circuitry to:
categorize (a) a first set of the candidate networks based on a first one of the performance metrics corresponding to first tier values, and (b) a second set of the candidate networks based on a second one of the performance metrics corresponding to second tier values; and
extract first features corresponding to the first set of the candidate networks and extract second features corresponding to the second set of the candidate networks; and
network analysis circuitry to perform network analysis by providing the first features and the second features to a network analyzer to identify particular ones of the candidate networks.

2. The apparatus as defined in claim 1, wherein the likelihood verification circuitry is to identify (a) the first tier values as performance metrics corresponding to an upper threshold and (b) the second tier values as performance metrics corresponding to a lower threshold.

3. The apparatus as defined in claim 1, further including benchmark evaluation circuitry to initiate benchmarking tests corresponding to operation information extracted from the candidate networks.

4. The apparatus as defined in claim 3, wherein the benchmark evaluation circuitry is to initiate the benchmarking tests corresponding to the target platform type to determine third performance metrics.

5. The apparatus as defined in claim 4, wherein the third performance metrics include at least one of latency, accuracy, power consumption or memory bandwidth.

6. The apparatus as defined in claim 3, wherein the operation information corresponds to at least one of an operation type, a kernel size or an input size.

7. The apparatus as defined in claim 1, wherein the first and second features include at least one of network adjacency features, layer connection information, or network graph information.

8. The apparatus as defined in claim 1, further including architecture modification circuitry to query a network knowledge database for prior modification information corresponding to the candidate networks.

9. The apparatus as defined in claim 8, wherein the architecture modification circuitry is to establish a starting search point by applying changes to the candidate networks.

10. An apparatus to identify candidate networks, comprising:
at least one memory;
machine readable instructions; and
processor circuitry to at least one of instantiate or execute the machine readable instructions to:
determine candidate networks corresponding to a combination of target platform characteristics, workload characteristics to be executed by a target platform, and historical benchmark metrics characteristics associated with the candidate networks, wherein the candidate networks are associated with performance metrics;
categorize (a) a first set of the candidate networks based on first values, and (b) a second set of the candidate networks based on second values;
identify (a) first features associated with the first set of the candidate networks and (b) second features associated with the second set of the candidate networks; and
feed a network analyzer with the first and second features to determine one or more of the candidate networks to be executed with the target platform.

11. The apparatus as defined in claim 10, wherein the processor circuitry is to cause identification of (a) performance metrics corresponding to an upper threshold as the first values, and (b) performance metrics corresponding to a lower threshold as the second values.

12. The apparatus as defined in claim 10, wherein the processor circuitry is to initiate benchmarking tests corresponding to operation information extracted from the candidate networks.

13. The apparatus as defined in claim 12, wherein the processor circuitry is to initiate the benchmarking tests corresponding to the target platform to determine third performance metrics.

14. The apparatus as defined in claim 13, wherein the processor circuitry is to identify the third performance metrics as at least one of latency, accuracy, power consumption or memory bandwidth.

15. The apparatus as defined in claim 12, wherein the processor circuitry is to identify operation information as at least one of an operation type, a kernel size or an input size.

16. The apparatus as defined in claim 10, wherein the first and second features include at least one of network adjacency features, layer connection information, or network graph information.

17. The apparatus as defined in claim 10, wherein the processor circuitry is to query a network knowledge database for prior modification information corresponding to the candidate networks.

18. The apparatus as defined in claim 17, wherein the processor circuitry is to initiate a starting search point by applying changes to the candidate networks.

19. A non-transitory machine readable storage medium comprising instructions that, when executed, cause processor circuitry to at least:
determine candidate networks corresponding to a combination of target platform characteristics, workload characteristics to be executed by a target platform, and historical benchmark metrics characteristics associated with the candidate networks, wherein the candidate networks are associated with performance metrics;
categorize (a) a first set of the candidate networks based on first tier values, and (b) a second set of the candidate networks based on second tier values;
identify (a) first features associated with the first set of the candidate networks and (b) second features associated with the second set of the candidate networks; and
feed a network analyzer with the first and second features to determine one or more of the candidate networks to be executed with the target platform.

20. The non-transitory machine readable storage medium as defined in claim 19, wherein the instructions, when executed, cause the processor circuitry to identify (a) performance metrics corresponding to an upper threshold as the first tier values, and (b) performance metrics corresponding to a lower threshold as the second tier values.

21. The non-transitory machine readable storage medium as defined in claim 19, wherein the instructions, when executed, cause the processor circuitry to initiate benchmarking tests corresponding to operation information extracted from the candidate networks.

22. The non-transitory machine readable storage medium as defined in claim 21, wherein the instructions, when executed, cause the processor circuitry to initiate the benchmarking tests corresponding to the target platform to determine third performance metrics.

23. The non-transitory machine readable storage medium as defined in claim 22, wherein the instructions, when executed, cause the processor circuitry to identify the third performance metrics as at least one of latency, accuracy, power consumption or memory bandwidth.

24. The non-transitory machine readable storage medium as defined in claim 21, wherein the instructions, when executed, cause the processor circuitry to identify operation information as at least one of an operation type, a kernel size or an input size.

25. The non-transitory machine readable storage medium as defined in claim 19, wherein the instructions, when executed, cause the processor circuitry to identify the first and the second features as at least one of network adjacency features, layer connection information, or network graph information.

26. (canceled)

27. (canceled)
